(19) United States
(12) Patent Application Publication
(10) Pub. No.: US 2010/0124479 A1
(43) Pub. Date: May 20, 2010

(54) LIFT ASSEMBLY FOR A VEHICLE

(75) Inventor: David W. Brooks, Plymouth, MI (US)

Correspondence Address: HOWARD & HOWARD ATTORNEYS PLLC, 450 West Fourth Street, Royal Oak, MI, 48067, US

(73) Assignee: D.M. BROOKS GLOBAL, INC., Plymouth, MI (US)

(21) Appl. No.: 12/619,795

(22) Filed: Nov. 17, 2009

Related U.S. Application Data
(60) Provisional application No. 61/115,142, filed on Nov. 17, 2008.

(51) Int. Cl. B60P 1/44

(52) U.S. Cl. 414/557

(57) ABSTRACT

A lift assembly adapted for use with a vehicle having a substantially horizontal cargo floor and a trailer hitch receiver, the lift assembly including a tongue member having a longitudinal axis and adapted for slidable insertion along the longitudinal axis into the receiver. A frame is attached to the tongue member and includes a pair of four-bar linkages, each of which includes rigid linkage members pivotably attached along substantially parallel pivot axes. Connected to the frame is a platform having a substantially planar load surface that defines a front edge and is substantially horizontally positioned. A first linkage member and the platform are moved together when the tongue member is in the receiver between a lowered state and an elevated state in which the horizontally positioned load surface is generally parallel with the cargo area floor and the load surface front edge is proximate to the cargo area floor. The platform has arcuate movement between the lift assembly lowered and elevated states and generally horizontal movement relative to the cargo bed as the lift assembly is moved toward and out of the elevated state.

### CROSS-REFERENCE TO RELATED APPLICATION

This application claims priority to U.S. Provisional Patent Application having Ser. No. 61/115,142 filed on Nov. 17, 2008, the entire disclosure of which is expressly incorporated herein by reference.

### BACKGROUND OF THE INVENTION

1. Field of the Invention

The present invention relates generally to lifting devices and more specifically to detachable platform lift assemblies adapted for connection to a vehicle such as a pickup truck through the vehicle's tubular trailer hitch receiver, and which can be installed and used by an individual without altering or modifying the vehicle.

2. Description of the Related Art

Various vehicle-mounted platform lifting devices have been in use for years. Typically, these devices include a platform that is raised and lowered vertically immediately behind a truck cargo bed between ground level and a desired height, which typically corresponds to the cargo bed floor level.

The main problem with many such conventional lifting devices is that the vehicle has to be permanently modified for product use. For example, the bumper may require removal. Alternatively or additionally, the lift assembly may require extensive structural interconnection to the truck such that it becomes significantly inconvenient to use it on a temporary basis. Another problem with such conventional lifting devices is that a user usually cannot install the device himself or remove it when he is finished using it. While these devices may be suitable for the particular, dedicated purpose, they generally are unsuitable for most users who do not wish to expend considerable time and effort, or to modify their vehicles, undertaking the permanent lift assembly installation normally entailed.

Another problem with some other conventional lift assemblies for use with pickup trucks is that they operate between the ground and the rear edge of the truck's lowered OEM tailgate, which has severely limited loading capacity compared to the cargo bed itself. OEM tailgates are not designed to accommodate loads greater than a few hundred pounds. Often the tailgate suspension cables, which extend between the vertical rear bed rails and the opposed side edges of the tailgate, are the weak link, and have been know to break under a tailgate load of only a couple of hundred pounds. Further, many conventional lift assemblies for pickup trucks are limited in capacity to only about 500 pounds. Most lift assemblies capable of handling significantly heavier loads are of the type requiring vehicle modification and/or extensive structural interconnection, as discussed above.

Other prior platform lift assemblies, particularly those light-duty versions that raise the platform to the edge of the truck's lowered tailgate, are attached to the rear of the truck through its trailer hitch receiver, which is typically located below the bumper and fixed to the vehicle frame. A problem with such prior lift assemblies is that they often substantially encroach into the truck's departure angle. Referring to FIG. 1, the departure angle θ is an indication of how a vehicle can drive off a steep hill or ramp without contacting underside elements aft of its rear wheels. When looking at a truck profile from the side, an imaginary straight line extends from the contact patch of the rear tire to the lowest hanging point of the truck behind its rear wheels. The angle between this line and the ground is the departure angle θ. Vehicles with a high departure angle θ can negotiate steep ramps without inflicting damage to these low-hanging elements. The departure angle is generally a function of vehicle ground clearance behind the rear wheels and the vehicle's longitudinal overhang distance between the rear axle and the lowest hanging points behind it. Referring to FIG. 1, the trailer hitch 20 inserted into the depicted truck's trailer hitch receiver 22 defines its departure angle θ_{T} which is clearly less than the departure angle would be with the receiver alone. Typically, most receiver-mounted lift assemblies according to the prior art will, compared to a trailer hitch 20, further decreases the departure angle θ. It is desirable to provide a lift assembly that, when installed, avoids reducing a vehicle's departure angle as much as possible, and preferably to no less than the departure angle θ_{T} defined by a trailer hitch that might otherwise be inserted into the receiver.

There is a need for a high capacity lift assembly that avoids the load being supported by the truck's OEM tailgate, can be quickly and easily installed by an individual without vehicle modification, and does not reduce the departure angle to an undesirable level.

### SUMMARY OF THE INVENTION

The present invention provides a new portable hydraulic platform lift assembly construction wherein the same can be utilized for allowing an individual to be able to use a high capacity, hydraulically controlled lift on a vehicle without having to alter or modify the vehicle, and to allow total portability of lift assembly. Further, the inventive lift assembly is easily installed to the vehicle's trailer hitch receiver by the individual user, and preserves the vehicle departure angle to a significant amount relative to prior art lift devices.

The general purpose of the present invention, which will be described in greater detail below, is to provide a new portable hydraulic platform lift that has many of the advantages of the lifting devices mentioned heretofore and many novel features that result in a new portable hydraulic platform lift which is not anticipated, rendered obvious, suggested, or even implied by any of the prior art lifting devices, either alone or in any combination thereof.

Certain embodiments of the present invention include an interchangeable platform attached to a frame including a four-bar linkage that is actuated by a hydraulic system that includes a control unit and a cylinder and piston assembly. The four-bar linkage controls platform motion and allows for loading heavy objects from ground level up to the bed level of a pick-up truck. A general use platform for most loads to rest upon for lifting is interchangeable with a platform of a different size and/or configuration that is adapted for other, special types of loads (e.g., recreational vehicles) and uses. The lift assembly structure includes an elongate tongue member that is inserted into and secured to the receiver much as a trailer hitch would be, to attach the unit to the vehicle. The frame is connected to the tongue member through a pivoting connection that permits the lift assembly to be rotated into an orientation for being stowed while attached to the vehicle, in which the departure angle is increased. The platform is rotatable between a substantially horizontal position in which the lift assembly is normally operated and a substantially vertical position in which the platform serves as tailgate when the lift assembly is stowed.

There has thus been outlined, rather broadly, certain features of an embodiment of the invention in order that the detailed description thereof may be better understood, and in order that the present contribution to the art may be better appreciated. Additional or alternative features of embodiments of the invention are described in further detail below.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

A primary object of the present invention is to provide a portable platform lift assembly that will overcome at least one of the shortcomings of prior art devices.

Another object of the present invention is to provide a portable platform lift assembly for allowing an individual to be able to use a high capacity, controlled lift on a vehicle without having to alter or modify the vehicle, and to allow easy installation and total portability of the lift assembly.

Another object is to provide a portable platform lift assembly that can be used to lift heavy objects from ground level at the rear of a vehicle by an individual user in an automated operation.

Another object is to provide a portable platform lift assembly that can be fully and easily installed and removed by an individual.

Another object is to provide a portable platform lift assembly that will not require any alteration or modification to the host vehicle, or extensive interconnection thereto, for the device to function.

Another object is to provide a portable platform lift assembly that has a unique motion that enables the device to operate around a vehicle bumper and allow direct access to a pickup truck's cargo bed floor, without encountering the OEM tailgate, which is load limiting.

Other objects and advantages of the present invention will become apparent to the reader and it is intended that these objects and advantages are within the scope of the present invention.

The present invention provides a lift assembly adapted for use with a vehicle having a trailer hitch receiver, the lift assembly including a tongue member having a longitudinal axis and adapted for slidable insertion along the longitudinal axis into the receiver, the lift assembly having lowered and elevated states when the tongue member is in the receiver. A frame is connected to the tongue member and includes at least one four-bar linkage comprising rigid first, second, third, and fourth members, each linkage member having first and second pivot points, the frame defining first, second, third, and fourth substantially parallel pivot axes that are substantially horizontal when the tongue member is in the receiver. The first and second linkage members are pivotably attached to each other at their respective first pivot points through which extends the first pivot axis; the second and third linkage members are pivotably attached to each other at their respective second pivot points through which extends the second pivot axis; the third and fourth linkage members are pivotably attached to each other at their respective first pivot points through which extends the third pivot axis; and the fourth and first linkage members are pivotably attached to each other at their respective second pivot points through which extends the fourth pivot axis. A platform is connected to the frame and has a substantially planar load surface, the first linkage member and the platform moveable together between the lift assembly lowered and elevated states. When the lift assembly is in its elevated state and with no ground-supported portion thereof extending therefrom, the frame has first and second orientations relative to the tongue member. The vertical distance between the tongue member longitudinal axis and the lowermost point of the lift assembly is substantially greater in the first orientation than in the second orientation, a vehicle departure angle defined by the lift assembly increased in the second orientation relative to the first orientation.

The present invention also provides a lift assembly adapted for use with a vehicle having a cargo area defining a substantially horizontal floor above ground level and a trailer hitch receiver located vertically between the cargo area floor and ground level, the lift assembly including a tongue member having a longitudinal axis and adapted for slidable insertion along the longitudinal axis into the receiver. A frame is attached to the tongue member and includes a pair of four-bar linkages, the linkages disposed on opposite sides of the tongue member longitudinal axis. Each of the linkages includes rigid first, second, third, and fourth members, with each linkage member having first and second pivot points. The frame has first, second, third, and fourth substantially parallel pivot axes extending between the pair of four-bar linkages, the pivot axes substantially horizontal when the tongue member is in the receiver. Respective to each of the pair of four-bar linkages, the first and second members are pivotably attached to each other at their respective first pivot points through which extends the first pivot axis; the second and third members are pivotably attached to each other at their respective second pivot points through which extends the second pivot axis; the third and fourth members are pivotably attached to each other at their respective first pivot points through which extends the third pivot axis; and the fourth and first members are pivotably attached to each other at their respective second pivot points through which extends the fourth pivot axis. A platform is connected to the frame, has a substantially planar load surface that defines a front edge and is substantially horizontally positioned. The first linkage members and the platform are moved together when the tongue member is in the receiver between a lift assembly lowered state in which the load surface is located at a height between that of the tongue member longitudinal axis and ground level and a lift assembly elevated state in which the horizontally positioned load surface is generally parallel with the cargo area floor and the load surface front edge is proximate to the cargo area floor, the platform having arcuate movement between the lift assembly lowered and elevated states and generally horizontal movement relative to the cargo bed as the lift assembly is moved toward and out of the elevated state.

To accomplish the above and related objects, the invention may be embodied in a form illustrated in the accompanying drawings, attention being called to the fact, however, that the drawings are illustrative only, and that changes may be made in the specific construction illustrated. Moreover, it is to be noted that the accompanying drawings are not necessarily drawn to scale or to the same scale. In particular, the scale of some of the elements of the drawings may be exaggerated to emphasize characteristics of the elements.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a partial side view of a pickup truck having a trailer hitch receiver, to is installed a trailer hitch in accordance with the prior art;

FIG. 2 is a partial side view of the pickup truck of FIG. 1, its tailgate removed, to which is installed a lift assembly according to an embodiment of the present invention;

FIG. 3 is a partial perspective side view of the installed lift assembly shown in FIG. 2 in an elevated state, with the vehicle shown in phantom lines;

FIG. 4 is a rear perspective view of the installed lift assembly shown in FIG. 2 in a lowered state, with the vehicle shown in phantom lines;

FIG. 5 is a side view of the installed lift assembly shown in FIG. 2 in an elevated state, with the vehicle shown in phantom lines;

FIG. 6 is a side view of the installed lift assembly shown in FIG. 2 in a state intermediate its lowered and elevated states, with the vehicle shown in phantom lines;

FIG. 7 is a side view of the installed lift assembly shown in FIG. 2 in its lowered state, with the vehicle, and the lift assembly in different states intermediate its elevated and lowered states, shown in phantom lines;

FIG. 8 is a side view of the lift assembly shown in FIG. 2 in a stowed configuration, with the vehicle shown in phantom lines;

FIG. 9 is an enlarged partial perspective view of one of the ground-engaging stabilizing feet of the lift assembly; and

FIG. 10 is a partial perspective side view of the installed lift assembly in an elevated state similar to FIG. 5, showing an alternative platform.

While the invention is susceptible to various modifications and alternative forms, specific embodiments thereof are shown by way of example in the drawings and may herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. Elements shown in more than one Figure that may be similarly configured have been indicated using the same reference numerals.

### DETAILED DESCRIPTION

Turning now to the drawings, in which similar reference numerals denote similar elements throughout the several views, a lift assembly embodiment according to the present invention is illustrated. The shown portable platform lift assembly 30 generally includes a removable, interchangeable platform 32 that is hydraulically actuated and allows for loading heavy objects (not shown) from ground level 34 up to the cargo bed floor level 36 of a pick-up truck 38. The truck's tailgate (not shown) is removed prior to installation of the lift assembly 30, which brings its platform 32 to a position substantially parallel with and adjacent to the end of the truck's cargo bed floor 46. The platform 32 has a substantially planar load surface 40 on which the objects of the load to be lifted or lowered are positioned. The platform 32 includes tie-down brackets 48 to which the load may be strapped to secure it during lift operation.

Movement of the lift assembly 30 between its elevated 42 and lowered 44 states, wherein the horizontally positioned platform 32 is respectively positioned adjacent to and substantially parallel with the cargo bed floor 46, and substantially at ground level 34, is controlled by a pair of four-bar linkages 50 partially defining an articulating frame of the lift assembly. The four-bar linkages 50a, 50b are substantially identical, laterally spaced, and operate in parallel. They each include four rigid linkage members 52, 54, 56, 58 each having first 60 and second 62 pivot points at which they are interconnected, as described further below. Four substantially parallel pivot axes 64, 66, 68, 70 extend laterally across the lift assembly 30 between the pair of four-bar linkages 50, and extend through the interconnected pivot points 60, 62 of the linkage members. Between the pair of linkages 50a, 50b, two members 68a, 68b are fixed together through the lift assembly frame 72, and during lift operation are fixed relative to the vehicle 38; and two other members 52a, 52b are fixed together to support the platform 32. The remaining four linkage members 54a, 54b, 58a, 58b of the pair of four-bar linkages 50a, 50b are swinging linkage members that move the platform-supporting members 52a, 52b and the platform 32 through an arcuate path relative to the vehicle 38 between the lift assembly elevated and lowered states 42, 44.

In a preferred embodiment, the pivot points 60, 62 of each four-bar linkage 50 in the lift assembly 30 are arranged to define a trapezoid, the two swinging linkage members 54, 58 interconnecting the vehicle-fixed third member 56 and the platform-supporting first member 52. The forward-most fourth member 58 which is shown disposed closest to the truck bumper 74 in the elevated state 42, never drops below the rearward-most second member 54 which is shown disposed furthest from the truck bumper 74 in the elevated state 42.

A torque tube 80 extends laterally between and is fixed to stub arms 82a, 82b of the fourth linkage members 58a, 58b. Relative to their first pivot points 60 at which the respective third 56 and fourth 58 members are pivotably attached together, the fourth member's stub arm 82 extends short distance in a direction away from the fourth member's second pivot point 62 at which it is connected to the platform-supporting first linkage member 52. The torque tube 80 is secured to the end of each stub arm 82 and fixed against rotation relative to the fourth members 58. The torque tube 80 is constructed in any desired shape and of any desired material, such as steel. A relatively greater amount of force acting on one 50a, 50b of the pair of four-bar linkages 50 is partially distributed to the other linkage 50a, 50b through the torque tube 80, which promotes simultaneous, smooth, stabilized, equivalent movement of the pair of four-bar linkages.

The frame 72 is connected to a tongue member 84 having an elongate structural beam 86 that is longitudinally inserted into and fixed to the trailer hitch receiver 22 of the truck 38. The tongue member 84, once in the receiver 22, supports the lift assembly 30 and the object on the platform 32 that is being lifted or lowered. The frame 72 has a pair of laterally spaced adjustable feet 90a, 90b connected thereto that are selectively rotated between a laterally extending stowed position and an operating position in which they extend downwardly to engage the ground 34, which supports and stabilizes the lift assembly 30 during operation. The feet 90 (one of which is shown in FIG. 9) are each provided with an adjusting mechanism 92 that allows its base 94 to drop vertically downward into engagement with the ground 34, after which the base 94 is secured against upward travel relative to the frame 72 during lift assembly operation.

Each foot 90 has a sleeve 96 pivotably attached to one of the laterally opposite ends of the frame's rearmost structure beam 100, and is lockable into a horizontally extending stowed position and the downwardly extending operating position shown in the various Figures. The sleeve 96 is provided with a screw 102 having a large, hand-turnable knob 14. A shaft 106 is telescopically engaged with the sleeve 96 and its exposed terminal end 108 is attached to the ground-engaging base 94. The foot shaft 106 is limited in its telescopic travel relative to the sleeve 96 by a longitudinally extending slot 110 provided in the shaft 106, in which the end or tip of the screw 102 is disposed. The end of the screw 12 engages the opposite end walls 112, 114 of the slot 110 at the longitudinal limits of shaft's telescopic travel inside of the sleeve 96. The slot 110 has a planar floor surface 116 that is angled relative to the shaft surface 118 in which the slot 110 is formed, with the slot 110 having a shallow end 120 near the foot base 94 and an opposite deep end 122. Once the foot 90 is in its downwardly extending operating position, the screw 102 is then adjusted to allow the foot shaft 106 to drop downwardly under gravity to a ground-engaging position in which the base 94 contacts the ground 34 or an intermediate structure, wherein the lift assembly 30 will be ground-supported. The screw 102 is then brought into engagement with the slot floor 116. Upward telescopic travel of the foot shaft 106 in the sleeve 96 is prevented by the abutting engagement of the tip of the screw 102 with the inclined floor surface 116. To permit the foot 90 to telescopically contract, the screw 102 is backed away from the slot floor 116. The compressive abutting engagement of the screw tip and the slot floor also inhibits the foot's telescopic extension, but backing the screw 102 slightly out of its engagement with the slot floor 116 will allow the foot 90 to then freely extend to the telescopic limit at which the slot wall 114 at the deep end 122 abuts the screw 102. The two feet 90, 90b are independently adjustable, and may be extended to different lengths as conditions warrant. It is preferred, however, that the ground 34 on which the truck is parked 38 and the feet 90 engage during lift operations be level and firm.

The tongue member 84 is used to attach and remove the lift assembly 30 from the hitch receiver 22 of the truck 38. Its elongated beam portion 86 has a longitudinal axis 130 along which it is inserted into and withdrawn from the receiver 22. Once the tongue member 84 is in the receiver 22, a pin 132 is laterally extended through aligned holes in the receiver 22 and tongue beam portion 86 to lock their relative position along the now horizontal longitudinal axis 130, which extends fore and aft relative to the vehicle 38. A threaded pin 132 may be used in a threaded hole in the tongue member 86 beam to further stabilize the tongue member 84 against side-to-side rocking or wobbling within the hitch receiver 22 as necessary. Alternatively, a specially designed, tapered pin 132 may be inserted into the aligned holes of the receiver 22 and the tongue member beam 86, and tightened to secure the lift assembly 30 to the receiver 22.

The hitch receiver 22 is a structural vehicle member that is used to interface with a class III trailer hitch of an automotive type application, the size and shape of which is emulated by the inserted beam 86 of the tongue member 84. However, it should be appreciated that the tongue member beam 86 may alternatively be sized to fit other types of hitch receivers 22, such as those for a class I or class II hitch, or the like. The interconnection of the tongue member 84 and the vehicle receiver 22 attaches the platform lift assembly 22 to the vehicle 38 in a quick connect/disconnect fashion. The tongue member 84 is constructed of any desired material, but preferably steel, and its beam 86 preferably has a solid, substantially square cross section of the size to appropriately fit the particular class of hitch receiver 22 the vehicle has. It is envisioned that relative to the same lift assembly 30, its tongue member 84, or only its beam portion 86, appropriate for one class of hitch may be interchangeable with that for another class of hitch. The tongue member 84, once locked longitudinally relative to the receiver 22, positions the remaining portions of the lift assembly 30 away from the truck 38 such that the intended relative positioning of the lift assembly 30 and the truck 38 is assured.

The tongue member 84 is pivotably attached to the structural beams 100 of the frame 72, which are fixed to the third linkage members 56a, 56b. The tongue member 84 also helps tie the structural beams 100 of the frame 72 together, and the connection between the tongue member 84 and the frame's structural beams 100 provides weight bearing support for the lift assembly 30 relative to the vehicle 38 to which it is installed.

The portion(s) of the platform 32 defining the generally planar load surface 40 is preferably formed of metal or other suitable material, with variable dimensions. The platform 32 is formed to any desired dimension based on the intended use, and may be foldable about hinge 134 as shown in the Figures, with the hinged, foldable portions 32a, 32b each defining a portion 40a, 40b of the load surface 40. The planar portion(s) 40a, 40b of the platform 32 defining the load surface 40 may be made from any desired materials such as steel or aluminum plate (e.g., commercially available tread plate), expanded metal, or other suitable materials. The platform 32 is constructed with a tubular understructure 136 which is secured to and supports its planar portions. The tubular understructure 136 is releasably connected through a hinge 138 to the platform-supporting first linkage members 52a, 52b which are themselves fixed together, which allows the platform 32 to be rotated about 90 degrees between substantially horizontal 140 and vertical 142 positions. When in its substantially horizontal position 140, the platform 32 is supported along the parallel first members 52a, 52b of the pair of four-bar linkages 50a, 50b and the lift assembly 30 is operational for movement between its lowered 44 and elevated 42 states. When in its substantially vertical position 142, with the lift assembly 30 in its elevated state 42 and stowed, the platform 32 serves as a tailgate that forms a rear wall of the truck's cargo bed. The planar load surface portions 40a, 40b of the platform 32 may be perforated or formed from heavy wire mesh, thereby allowing the passage of air there-through when serving as a tailgate to reduce wind resistance when the truck 38 is being driven with the stowed lift assembly 30 installed.

The linkage members 52, 54, 56, 58 define an arcuate travel path of platform movement between the lift assembly elevated 42 and lowered 44 states, and maintains in those states 42, 44 and in all intermediate states therebetween, a substantially horizontal orientation of the platform-supporting members 52a, 52b of the pair of four-bar linkages 50a, 50b. The rigid members of each four-bar linkage 50 are constructed from any desired material, preferably steel, and are each shaped or configured, and interconnected with each other to not only maintain a substantially horizontal platform orientation during operation, but to accommodate and not encroach the spaces occupied by OEM rear bumpers 74 and other hardpoints typically found in pickup trucks 38 that have had their tailgates removed. Thus, the platform lift assembly 30 accommodates the existing environment typical of most pickup trucks 38, and avoids impact to that environment. In the depicted embodiment, the swinging second and fourth members 54, 58 of each four-bar linkage 50 are shown as being substantially straight between their respective pivot points 60, 62. Alternatively, the linkage members 52, 54, 56, 58 may be curved or otherwise formed to provide a path through which the lift assembly 30 can move between its operational end states, and be stowed on-board the vehicle 38, while providing desired clearances to vehicle hardpoints without requiring modification of the vehicle 38.

Thus, the lift assembly 30 includes a tongue member 84 having a longitudinal axis 130 and adapted for slidable insertion along the longitudinal axis 130 into the vehicle's trailer hitch receiver 22. The frame 72 is pivotably attached to the tongue member 84 and includes a pair of four-bar linkages 50, the linkages 50a, 50b disposed on opposite sides of the longitudinal axis 130. Each of the linkages 50 includes rigid first 52, second 54, third 56, and fourth 58 linkage members, with each of these linkage member's having first 60 and second 62 pivot points.

The frame 72 has first 64, second 66, third 68, and fourth 70 substantially parallel pivot axes extending between the pair of four-bar linkages 50a, 50b, and that are substantially horizontal when the tongue member 84 is in the receiver 22. Respective to each of the pair of four-bar linkages 50, the first 52 and second 54 members are pivotably attached to each other, preferably through a bolted connection, at their respective first pivot points 60 through which extends the first pivot axis 64. Likewise, the second 54 and third 56 members are pivotably attached to each other at their respective second pivot points 62 through which extends the second pivot axis 66. Likewise, the third 56 and fourth 58 members are pivotably attached to each other at their respective first pivot points 60 through which extends the third pivot axis 68. And likewise, the fourth 58 and first 52 members are pivotably attached to each other at their respective second pivot points 62 through which extends the fourth pivot axis 70.

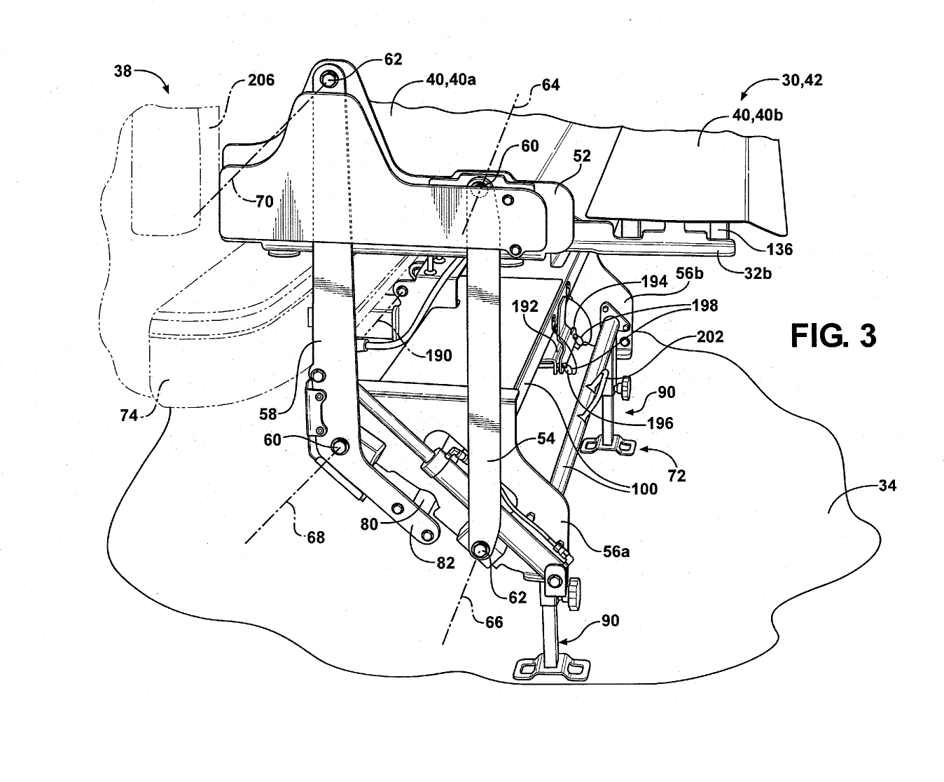

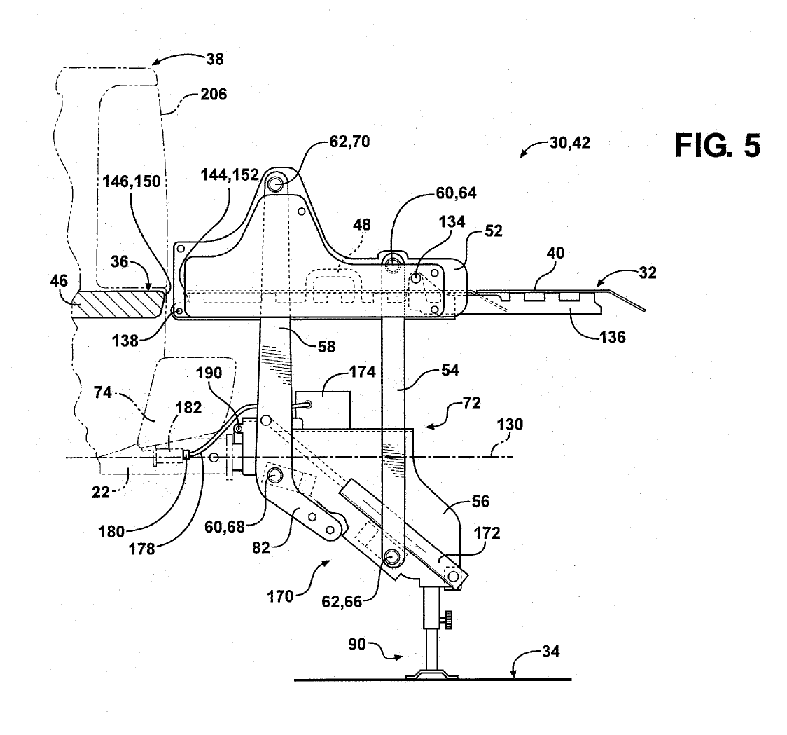

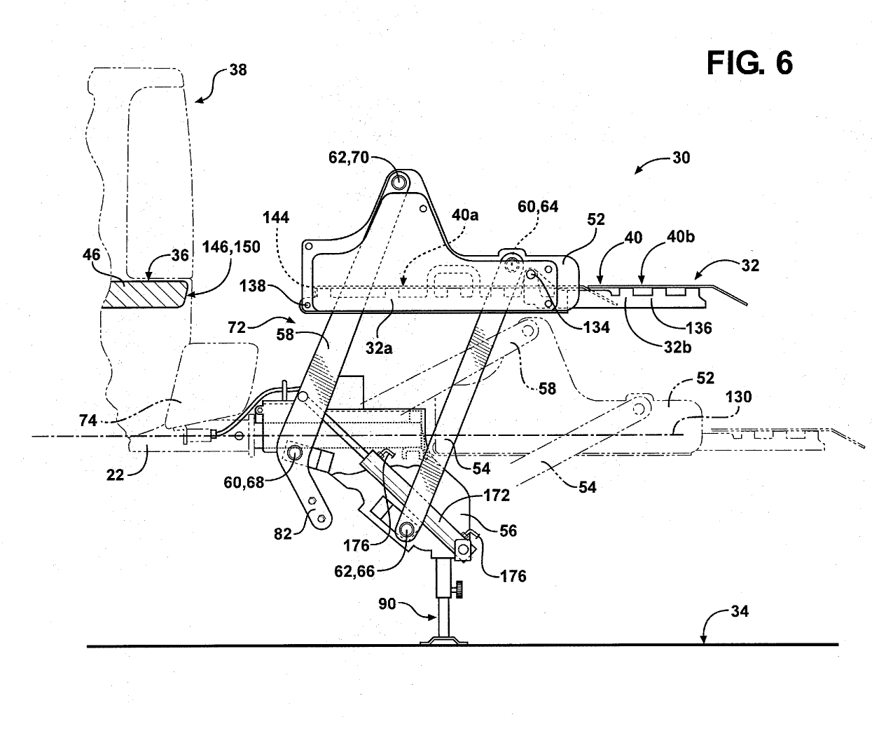

The platform 32 is connected to the frame 72 through the first members 52a, 52b of linkages 50a, 50b, and has a substantially planar load surface 40 defining a front edge 144. The load surface 40 has a substantially horizontal operating position 140, and the first linkage members 52 and the horizontally positioned platform 32 move together between a lowered state 44 in which the load surface 40 is located at a height between that of the tongue member longitudinal axis 130 and ground level 34, and an elevated state 42 in which the horizontally positioned load surface 40 is generally parallel with the cargo area floor level 36 and the load surface front edge 144 is proximate to the cargo area floor 46, the platform 32 having arcuate movement between these lift assembly states 42, 44. The horizontal orientation of the platform 32 is maintained throughout the lifting and lowering movement due in part to the fourth pivot axis 70 being vertically higher than the first pivot axis 64, which causes the platform 32 to prescribe a noncircular arc about the third pivot axis 68 that facilitates the horizontally positioned platform 32 also having a generally horizontal movement relative to the cargo bed of the truck 38 as the lift assembly 30 is moved toward and out of the elevated state 42. This allows the platform 32 to be positioned proximate to the rear edge 146 of the cargo area floor 46 without contacting the truck's OEM rear bumper 74. Notably, referring to FIGS. 3 and 5, in the elevated state 42, the third and fourth pivot axes 68, 70 are substantially vertically aligned with the front edge 144 of the load surface 40 positioned forward of axes 68, 70 and above the bumper 74.

The rear edge 146 of the cargo area floor 46 can be defined as being located at a first location 150 in a direction axially along the tongue member longitudinal axis 130. In the elevated state 42, the front edge 144 of the platform load surface 40 is preferably located at a second location 152 along that axis 130 within about six inches and rearward of the first location 150. Owing to the platform's path of movement having a component along the longitudinal axis 130 rather than being solely vertically, which allows the platform 32 to be brought close to the rear edge 146 of the cargo bed floor 46 without necessitating removal or modification of the rear bumper 74, the front edge 144 of the load surface 40 in the lowered state 44 can be defined as being at a third location 154 along the longitudinal axis 130 that is at a substantially greater distance than the second location 152 is from the first location 150.

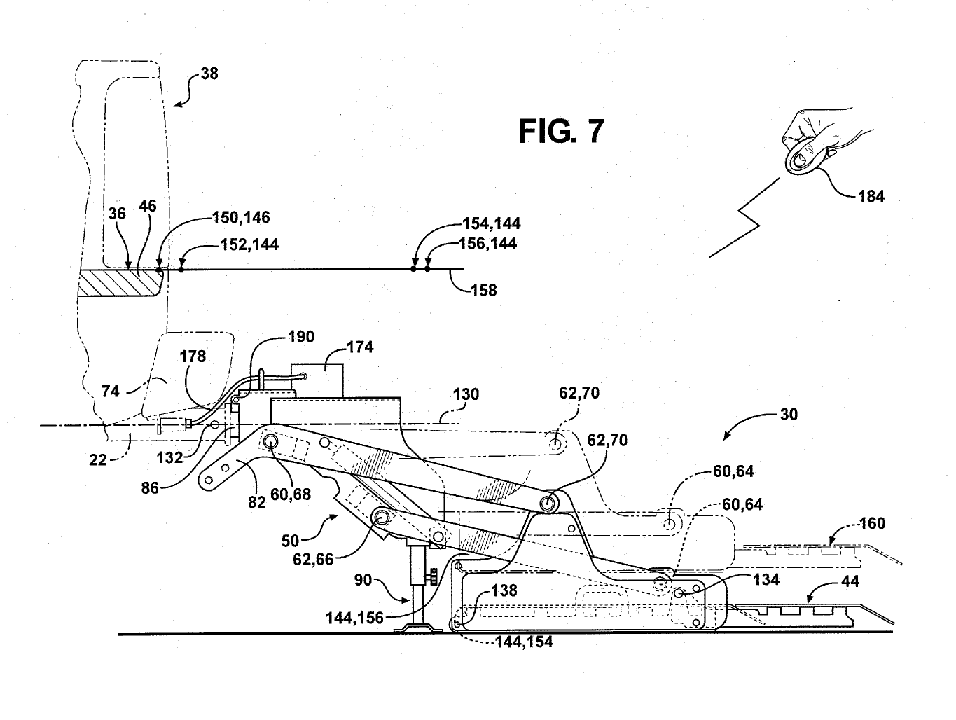

The platform movement is designed to move around the rear bumper 74 in an arc, which results in the load surface front edge 144 having various locations along the longitudinal axis 130 at various lift assembly states 160 intermediate its lowered 44 and elevated 42 states. In the described embodiment, the load surface front edge 144 has fourth location 156 that is at a slightly greater distance than the third location 154 is from the first location 150, and this fourth location 156 occurs when the second and fourth swinging linkage members 54, 58 are substantially horizontal, as shown in phantom lines in FIG. 7. For illustrative clarity, imaginary straight line 158 parallel to longitudinal axis 130 is provided in FIG. 7, on which are indicated the above-described first location 150 corresponding to the cargo bed floor rear edge 146, and the second 152, third 154 and fourth 156 locations corresponding to the platform load surface front edge 144, along the axial direction of longitudinal axis 130.

A hydraulic system 170 actuates the four-bar linkage mechanism 50 of the lift assembly 30. The hydraulic system 170 consists of a pump (not shown) and a hydraulic cylinder and piston assembly 172 (hereinafter also referred to as hydraulic cylinder 172) attached to each of the pair of four-bar linkages 50. The hydraulic system 170 is used to controllably induce and prevent motion of the four-bar linkages 50a, 50b. Optionally, additional hydraulic cylinders 172 may be added to the hydraulic system 170 and connected to the pair of linkages 50 to increase the lifting power of the lift assembly 30. The corresponding third members 56a, 56b of the pair of four-bar linkages 50a, 50b, located opposite the first linkage members 52a, 52b along which the horizontally positioned platform 32 is supported, are fixed relative to the tongue member 84 during operation of the lift assembly 30. These third linkage members 56a, 56b are both fixed to a central portion of frame 72 that extends laterally between the pair of four-bar linkages 50a, 50b, and thus are fixed to each other. The central portion of frame 72 includes a plurality of structural beams 100 that support the weight of the lift assembly 30 and the lifted object. The structural beams 100 of the frame 72 also tie the platform 32 and linkage members 52, 54, 56, 58 to the tongue member 84. The rigid structural beams 100 are constructed of suitable materials, preferably steel, and are shaped and configured to add additional strength to the lift assembly 30. The structural beams 100 are also used to add additional components and options to the lift assembly 30 if later desired.

A hydraulic control unit 174, in which the hydraulic pump (not shown), associated valves (not shown) and an electronic controller having a radio receiver (not shown) to selectively actuate the pump and direction of fluid control, are arranged in a closed, weatherproof module, is affixed to the frame's structural beams 100. Hydraulic pumps, valves and related hydraulic control circuits, and electronic controllers and radio receivers, and their operations as described below, are all well known to those of ordinary skill in their respective arts, and are not further discussed herein.

Two pairs of hydraulic fluid lines 176 extend from the module 174, one pair of lines 176 in operable fluid communication with each of the hydraulic cylinders 172, to direct fluid into and out of chambers (not shown) defined by the opposed sides of the axially moveable piston (not shown) in each hydraulic cylinder 172, as is well-known to those of ordinary skill in the art, to axially elongate or contract the hydraulic cylinder 172. Each hydraulic cylinder 172 is pivotably attached at its opposite ends to the third 56 and fourth 58 members of a four-bar linkage 50. The cylinder assembly 172 is hydraulically forced to elongate during lifting, i.e., to move the lift assembly 30 towards its elevated state 42; and is hydraulically forced or controllably allowed to contract during lowering, i.e., to move or facilitate movement of the lift assembly 30 towards its lowered state 44. The torque tube 80 interconnecting the fourth linkage members 58a, 58b prevents the effect of “crab walking” often experienced when two hydraulic cylinders are used to move a lift platform through a pair of parallel-acting linkages, by distributing between the two linkages differences in the forces the cylinders exert.

An electrical wire harness 178 also extends from the module 174, and its plug 180 is connected to the standard seven-pin trailer electrical power receptacle 182 of the truck 38 typically located adjacent the receiver 22. One pole (not shown) of this receptacle 182 provides constant voltage, and is connected to the electrically-driven hydraulic pump located inside the module 174. Actuation of the hydraulic system 170 to elongate or contract the hydraulic cylinders 172 is responsive to an associated signal received from a user-actuated remote control transmitter 184 which wirelessly communicates radioed control signals to the control module 174 from the user, who is able to stand safely away from the lift assembly 30 during its operation to avoid possible injury and better oversee the lifting and lowering operations. Once the desired platform position is reached, the user ceases transmitting the powering signal, and the pump stops. A valve in the hydraulic system 170 causes the motion of the platform 32 to “lock” and hold the platform 32 in its current position until power is re-applied to further actuate the hydraulic system 170.

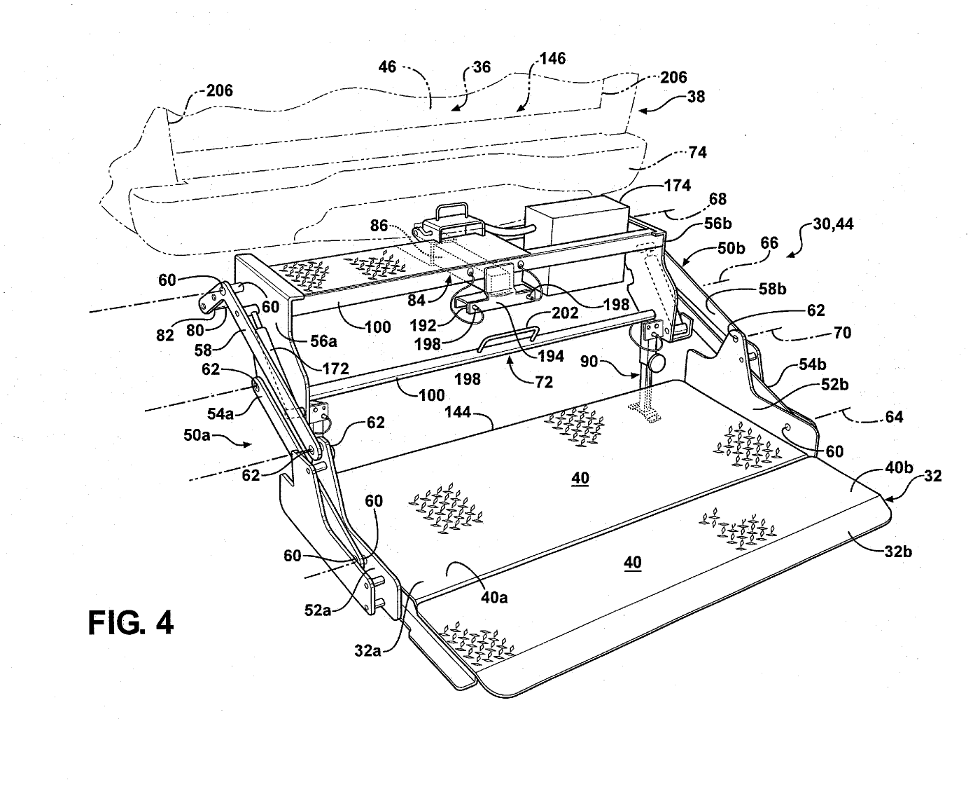

As noted above, the tongue member 84 is pivotably attached to the structural beams 100 of the frame 72. The pivotable connection between the tongue member 84 and the frame 72 is about a fifth pivot axis 190 substantially parallel with the first, second, third, and fourth pivot axes 64, 66, 68, 70 and located closely rearward of the bumper 74. The tongue member 84 extends further rearward along the direction of its longitudinal axis 130 to a downwardly depending and laterally extending first flange 192. The tongue member first flange 192 is selectively superposed by a downwardly depending and laterally extending second flange 194 fixed to a structural beam 100 of the frame 72. The first 192 and second 194 flanges each have a pair of laterally spaced holes 196, best shown in FIGS. 3 and 4. The pairs of holes 196 are respectively aligned when the first and second flanges 192, 194 are superposed. A pair of tethered pins 198 is inserted through the aligned holes 196 to rigidly fix the frame 72 to the tongue member 84, and prevent their relative rotation about the fifth pivot axis 190 during lifting and lowering operations.

At the completion of lift assembly operations, the lift assembly 30 is positioned in its elevated state 42, and the rearmost portion 32b of the hinged platform 32 is folded forward about hinge 134 over the frontmost portion 32a such that their respective load surface portions 40b, 40a are interfacing. The platform 32 is then pivoted forward about the hinge 138, through which the platform 32 is releasably connected to the first linkage members 52, and into its generally vertical position 142. The platform 32 may be secured into its vertical position 142, for example by a latching mechanism (not shown). The feet 90 are then collapsed and rotated laterally inward and locked into their stowed positions.

At this point, the lift assembly 30 is now in its elevated state 42 and the frame 72 has a first orientation 200 relative to the tongue member 84. The user may now wish to remove the lift assembly 30 from the vehicle 38, which entails disconnecting the electrical harness plug 180 from the vehicle's electrical receptacle 182, removing the locking pin 132 that extends through the aligned holes in the receiver 22 and tongue member beam 86, and pulling the lift assembly 30 rearward as a unit along its longitudinal axis 130 using the handle 202 fixed to the rearmost frame structural beam 100, to disengage the lift assembly 30 from the receiver 22. The lift assembly 30 may be pulled rearwardly onto a specially-adapted wheeled dolly (not shown) on which the lift assembly 30 can be rolled away and stored in a space-efficient manner. The truck's tailgate (not shown) is then reinstalled. It is envisioned that the above-mentioned wheeled dolly may also be adapted for use in moving the objects that are loaded and unloaded using the lift assembly 30, and that provisions could be made for its storage on the lift assembly frame 72.

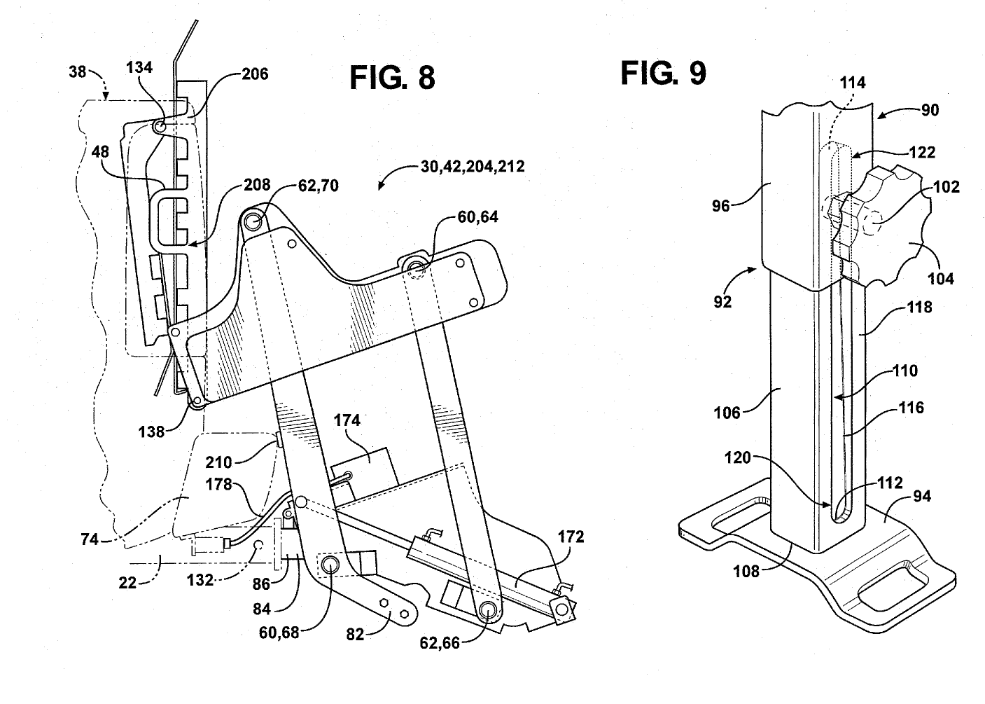

Alternatively, the user may instead now wish to stow the installed lift assembly 30, still in its elevated state 42. Doing this entails the tethered pins 198 then being pulled from the aligned pairs of holes 196, and rotating the latched-together frame 72 and platform 32 forward about the fifth pivot axis 190 into a second orientation 204 between the frame 72 and the tongue member 84. After rotating the latched-together frame 72 and platform 32 forward, the lift assembly 30 may be secured into its second orientation 204 by latching together the tongue member 84 and the frame 72. In the second orientation 204, the platform 32 is now positioned slightly more vertically upright and substantially closes the rear cargo bed opening outlined by the inside edges of vertical rear bed rails 206 and the cargo area floor 46, thus serving as a tailgate and providing a rear wall 208 to the truck's cargo area, as shown in FIG. 8. The hydraulic cylinders 172 may then be slightly further extended to bring rubber snubber pads 210 located on the forward sides of the fourth linkage members 58a, 58b into compressive contact with the truck's rear bumper 74, thereby firmly securing the lift assembly 30 into its fully stowed position 212. The electrical power to the hydraulic control unit 174 may then be disconnected by conventional means such as through a switch (not shown) or by disconnecting its harness to prevent its accidental actuation.

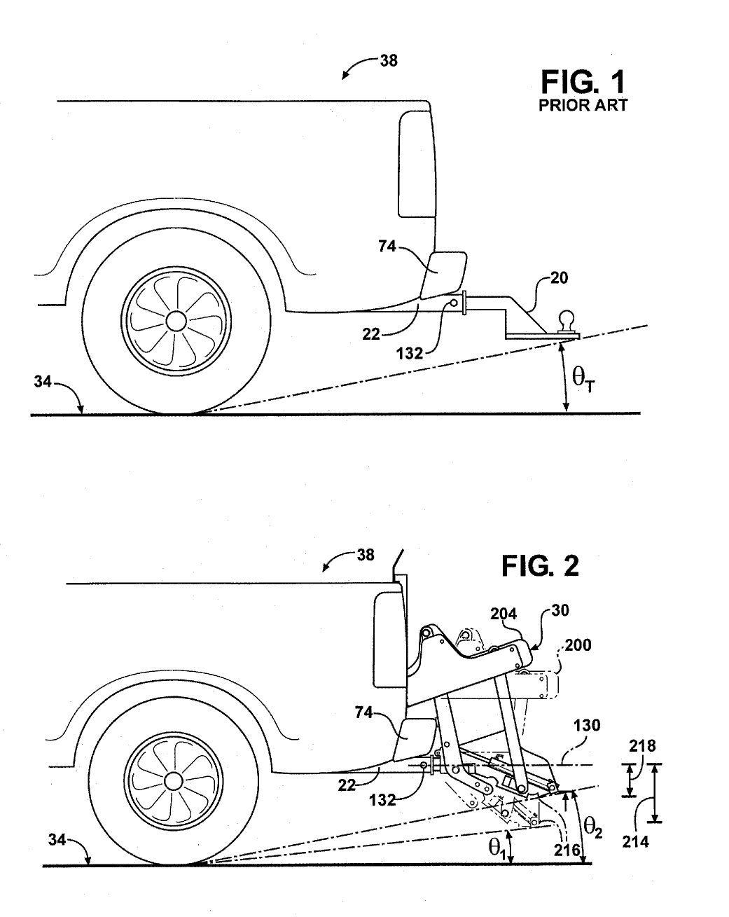

With reference to FIGS. 1 and 2, once in its above-mentioned first orientation 200 between the frame 72 and the tongue member 84, wherein the lift assembly 30 is in its elevated state 42 and the feet 90 have been stowed, and there is no ground-supported portion of the lift assembly 30 extending from it, there is a first vertical distance 214 between the tongue member longitudinal axis 130 and the lowermost point 216 of the lift assembly 30 that establishes a first departure angle θ₁ (FIG. 2). Once in its above-mentioned second orientation 204 between the frame 72 and the tongue member 84, however, there is a second vertical distance 218 between the tongue member longitudinal axis 130 and the lowermost point 216 of the lift assembly 30 that establishes a second departure angle θ₂ that is substantially greater than angle θ₁ (FIG. 2) and which is expected to be no less than angle θ_{T} established by trailer hitch 20 instead installed in the receiver 22 (FIG. 1).

The portable hydraulic platform lift assembly 30 may be configured with a multiple of different capacities, sizes and/or configurations for differing applications and uses. For example, in one embodiment, the lift is configured for an 1100 pound vertical lift, which the above described lift assembly embodiment has achieved with its hydraulic system producing a pressure of about 2200 psig. It should be appreciated that the combined force exerted by the hydraulic cylinders, to vertically lift an 1100 pound load, is greater than 1100 pounds due to the kinematic arrangement through which the hydraulic system and linkage mechanism operates. The hydraulic system can be reconfigured to adapt to different environments and load capacities such as, for example, by varying the size or number of hydraulic cylinders. The design of the linkages 50 can be modified to provide different kinematically arranged travel paths which suit various applications and uses.

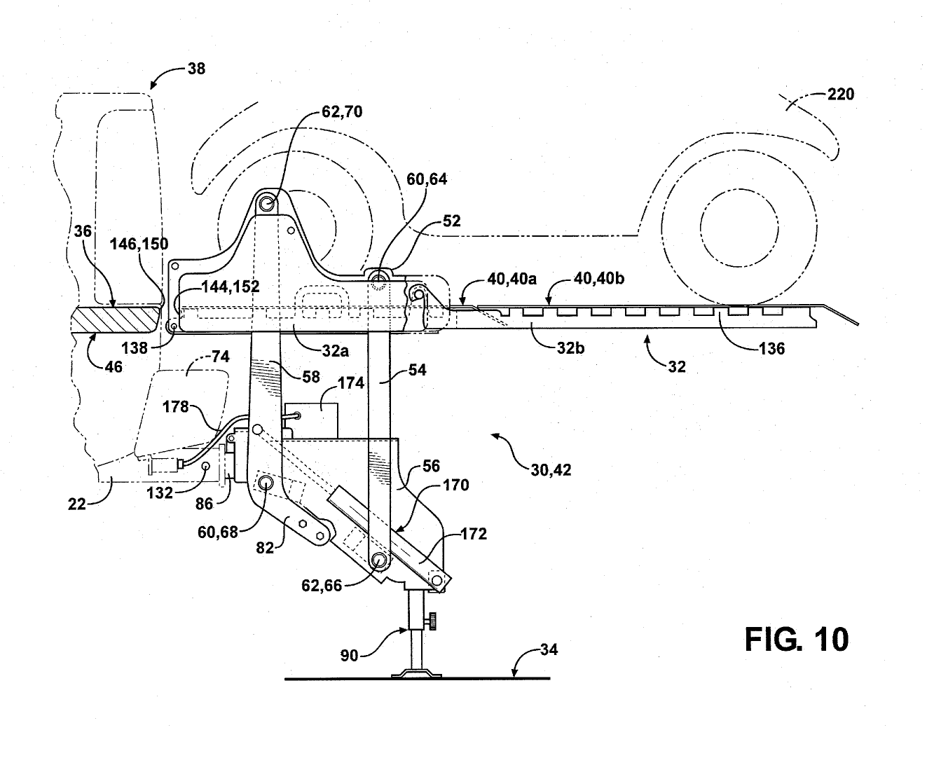

Additionally, as shown in FIG. 10, the general use platform 32 described above can be removed from the first linkage members 52 at its releasable hinged connection 138 and interchanged with another, longer platform 32 more particularly adapted for lifting an all terrain vehicle (ATV) 220 to the cargo bed 46. It is envisioned at a plurality of different interchangeable platforms 32, each more particularly suited for a different use or type of load (e.g., for motorcycles, snowmobiles, animal cages, objects on pallets, . . . etc. . . . ) can be made available to users.

The herein described portable hydraulic platform lift assembly is intended to be used as a mobile/portable lifting device for lifting heavy objects into the bed of pick-up trucks, SUV's, or other types of vehicles having a suitable trailer hitch receiver. It provides a trailer hitch-type interface to a receiver-equipped vehicle, which provides a quick means of easy attachment and removal. Once the tongue member of the portable hydraulic platform lift assembly has been secured to receiver of the host vehicle, and the electrical connection from the hydraulic system is made to the vehicle's electrical system via the trailer electrical power receptacle, the lift assembly is ready for use.

As to a further discussion of the manner of usage and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A lift assembly adapted for use with a vehicle having a trailer hitch receiver, said lift assembly comprising:
a tongue member having a longitudinal axis and adapted for slidable insertion along said longitudinal axis into the receiver, said lift assembly having lowered and elevated states when said tongue member is in the receiver;
a frame connected to said tongue member and comprising at least one four-bar linkage comprising rigid first, second, third, and fourth members, each said linkage member having first and second pivot points, said frame defining first, second, third, and fourth substantially parallel pivot axes that are substantially horizontal when said tongue member is in the receiver, said first and second linkage members pivotably attached to each other at their respective said first pivot points through which extends said first pivot axis, said second and third linkage members pivotably attached to each other at their respective said second pivot points through which extends said second pivot axis, said third and fourth linkage members pivotably attached to each other at their respective said first pivot points through which extends said third pivot axis, and said fourth and first linkage members pivotably attached to each other at their respective said second pivot points through which extends said fourth pivot axis; and
a platform connected to said frame and having a substantially planar load surface, said first linkage member and said platform moveable together between said lift assembly lowered and elevated states, said platform positioned higher in said lift assembly elevated state than in said lift assembly lowered state;
wherein, when said lift assembly is in its said elevated state and with no ground-supported portion thereof extending therefrom, said frame has first and second orientations relative to said tongue member, the vertical distance between said tongue member longitudinal axis and the lowermost point of said lift assembly being substantially greater in said first orientation than in said second orientation, a vehicle departure angle defined by said lift assembly increased in said second orientation relative to said first orientation.

2. The lift assembly of claim 1, wherein said platform has selective operating and stowed positions relative to said frame in which said load surface is substantially horizontal and substantially vertical, respectively.

3. The lift assembly of claim 2, wherein said platform in its said stowed position defines a rear wall to a cargo area of the vehicle.

4. The lift assembly of claim 1, wherein the vehicle with which said lift assembly is adapted for use has a cargo bed adjacent to which said platform is positioned in said lift assembly elevated state, and said platform has an arcuate movement between said lift assembly lowered and elevated states and generally horizontal movement relative to the vehicle cargo bed as said lift assembly is moved into and out of its said elevated state.

5. A lift assembly adapted for use with a vehicle having a cargo area defining a substantially horizontal floor above ground level and a trailer hitch receiver located vertically between the cargo area floor and ground level, said lift assembly comprising:
a tongue member having a longitudinal axis and adapted for slidable insertion along said longitudinal axis into the receiver;
a frame attached to said tongue member and comprising a pair of four-bar linkages, said linkages disposed on opposite sides of said tongue member longitudinal axis, each of said linkages comprising rigid first, second, third, and fourth members, each said linkage member having first and second pivot points, said frame having first, second, third, and fourth substantially parallel pivot axes extending between said pair of four-bar linkages, said pivot axes substantially horizontal when said tongue member is in the receiver, wherein, respective to each of said pair of four-bar linkages, said first and second members are pivotably attached to each other at their respective said first pivot points through which extends said first pivot axis, said second and third members are pivotably attached to each other at their respective said second pivot points through which extends said second pivot axis, said third and fourth members are pivotably attached to each other at their respective said first pivot points through which extends said third pivot axis, and said fourth and first members are pivotably attached to each other at their respective said second pivot points through which extends said fourth pivot axis; and
a platform connected to said frame and having a substantially planar load surface defining a front edge and substantially horizontally positioned, said first linkage members and said horizontally positioned platform moved together when said tongue member is in the receiver between a lift assembly lowered state in which said load surface is located at a height between that of said tongue member longitudinal axis and ground level and a lift assembly elevated state in which said horizontally positioned load surface is generally parallel with the cargo area floor and said load surface front edge is proximate to the cargo area floor, said platform having arcuate movement between said lift assembly lowered and elevated states and generally horizontal movement relative to the cargo bed as said lift assembly is moved toward and out of its said elevated state.

6. The lift assembly of claim 5, wherein when said tongue member is in the receiver, relative to said tongue member longitudinal axis, the cargo floor has a rear edge located at a first location therealong, and said platform load surface front edge is located at a second location therealong in said lift assembly elevated state and at a third location therealong in said lift assembly lowered state, said third location at a substantially greater distance than said second location is from said first location.

7. The lift assembly of claim 6, wherein when said tongue member is in the receiver, relative to said tongue member longitudinal axis, said platform load surface front edge is located at a fourth location along said tongue member longitudinal axis at a lift assembly state intermediate its said lowered and elevated states, said fourth location at a greater distance than said third location is from said first location.

8. The lift assembly of claim 7, wherein said load surface is at a height below said tongue member longitudinal axis when said load surface front edge is at said fourth location.

9. The lift assembly of claim 6, wherein said second location is within about six inches and rearward of said first location.

10. The lift assembly of claim 5, wherein, in said lift assembly lowered and elevated states and states intermediate thereto, said first pivot axis is vertically below said fourth pivot axis and said second pivot axis is vertically below said third pivot axis.

11. The lift assembly of claim 5, wherein said first linkage members are both fixed to said platform.

12. The lift assembly of claim 5, wherein said frame further comprises a central portion extending laterally between said second, third, and fourth linkage members said third linkage members both fixed to said central portion.

13. The lift assembly of claim 5, wherein, when said tongue member is in the receiver, said third pivot axis is located substantially closer vertically to the cargo area floor than to ground level, and said platform load surface front edge prescribes a non-circular arc about said third pivot axis during platform movement between said lift assembly lowered and elevated states, said load surface front edge located forward of said third pivot axis in said elevated state.

14. The lift assembly of claim 13, wherein said third and fourth pivot axes are substantially vertically aligned in said elevated state.

15. The lift assembly of claim 5, further comprising a torque tube extending laterally between and non-rotatably fixed to said fourth linkage members, a relatively greater amount of force acting on one of said pair of four-bar linkages being partially distributed to the other through said torque tube.

16. The lift assembly of claim 5, further comprising a hydraulic cylinder and piston assembly extending between and attached to said third and fourth members of at least one of said pair of four-bar linkages, said cylinder and piston assembly having an elongated state and a contracted state between which it changes length responsive to fluid received and expelled by said cylinder and piston assembly, movement of said platform between said lift assembly elevated and lowered states effected by controlled changes in the length of said cylinder and piston assembly.

17. The lift assembly of claim 16, further comprising a hydraulic control unit in fluid communication with said cylinder and piston assembly, fluid flow to and from said cylinder and piston assembly regulated by said hydraulic control unit.

18. The lift assembly of claim 17, wherein a user is in operating communication with said hydraulic control unit via a remote control unit.

19. The lift assembly of claim 18, wherein said remote control unit is in wireless communication with said hydraulic control unit.

20. The lift assembly of claim 5, wherein, when said lift assembly is in its said elevated state and with no ground-supported portion thereof extending therefrom, said frame has first and second orientations relative to said tongue member, the vertical distance between said tongue member longitudinal axis and the lowermost point of said lift assembly being substantially greater in said first orientation than in said second orientation, a vehicle departure angle defined by said lift assembly increased in said second orientation relative to said first orientation.
